(19) United States
(12) Patent Application Publication
(10) Pub. No.: US 2026/0168723 A1
(43) Pub. Date: Jun. 18, 2026

(54) REFRIGERATOR

(71) Applicant: LG Electronics Inc., Seoul (KR)

(72) Inventors: Heejun LEE, Seoul (KR); Hongshin CHO, Seoul (KR); Jinho CHANG, Seoul (KR); Bohyeon LEE, Seoul (KR)

(21) Appl. No.: 19/416,651

(22) Filed: Dec. 11, 2025

(30) Foreign Application Priority Data
Dec. 18, 2024 (KR) 10-2024-0189726
Mar. 26, 2025 (KR) 10-2025-0038929

(51) Int. Cl. F25D 23/02; E05F 15/614; E05F 15/75; F25D 29/00

(52) U.S. Cl. CPC F25D 23/028; E05F 15/614; E05F 15/75; F25D 29/005; E05Y 2900/31; F25D 2323/02

(57) ABSTRACT

A refrigerator includes: a cabinet having a storage space; a door that opens and closes the storage space; a hinge device configured to allow the door to rotate relative to the cabinet; a door opening and closing device configured to open and close the door and including a driver; and a controller configured to control the door opening and closing device. The controller is configured to: operate the driver in a forward direction to automatically open the door, stop the driver when an opening of the door is completed, and operate the driver in a reverse direction to automatically close the door when it is detected that the driver is being operated in the reverse direction by an external force in a state in which the driver is stopped.

### CROSS-REFERENCE TO RELATED APPLICATIONS

This application claims the benefit of Korean Patent Application No. 10-2024-0189726, filed on Dec. 18, 2024, and Korean Patent Application No. 10-2025-0038929, filed on Mar. 26, 2025. The disclosures of the prior applications are incorporated by reference in their entirety.

### BACKGROUND

The present disclosure relates to a refrigerator.

In general, a refrigerator is a home appliance for storing foods in an internal storage space, which is shield by a door, at a low temperature by low temperature air.

The storage space is surrounded by an insulating wall so that an inside of the storage space is maintained at a temperature lower than an outside temperature. Depending on a temperature range of the storage space, the storage space may be called a refrigerating chamber or a freezing chamber.

To put an object into or take the object out of the storage space, the user opens the door.

Typically, the door is rotatably installed on the cabinet, and a gasket is provided between the door and the cabinet. Therefore, when the door is closed, the gasket seals tightly between the door and the cabinet, preventing cold air from leaking from the storage space. The greater a sealing force of this gasket, the greater an effect of preventing cold air from leaking.

To increase a sealing force of the gasket, the gasket may be formed of a rubber, and a magnet may be provided within the gasket. However, as the sealing force of the gasket increases, a greater force is required to open the door.

Accordingly, a refrigerator with automatic door opening functions has recently been introduced. A related prior art document is China Utility Model Registration No. 218324468.

### SUMMARY

One embodiment provides a refrigerator in which a door can be automatically opened and an opening angle of the door increases when the door is automatically opened.

Alternatively or additionally, one embodiment provides a refrigerator in which a door can be automatically opened and closed.

Alternatively or additionally, one embodiment provides a refrigerator in which, upon initial automatic door opening, a first operating portion separates a gasket of a door from a cabinet, thereby reducing excessive load on a driver.

Alternatively or additionally, one embodiment provides a refrigerator in which a door can be opened manually by a user in addition to automatically opening.

Alternatively or additionally, one embodiment provides a refrigerator that prevents damage to a driver by stopping the driver when an obstacle is detected during an automatic opening process of the door.

Alternatively or additionally, one embodiment provides a refrigerator that prevents damage to a driver by stopping the driver when an obstacle is detected during an automatic closing process of the door.

Alternatively or additionally, one embodiment provides a refrigerator capable of automatically opening or automatically closing a door by recognizing a door opening command or a door closing command in a state in which the driver is stopped after an obstacle is detected during a door opening process or a door closing process.

Alternatively or additionally, one embodiment provides a refrigerator that enables automatic door closing when a force in a door closing direction is detected while the driver is stopped after an automatic door opening is completed.

A refrigerator according to one aspect may include a cabinet having a storage space; a door that opens and closes the storage space; a hinge device to allow the door to rotate relative to the cabinet; a door opening and closing device to open and close the door and including a driver; and a controller to control the door opening and closing device.

The controller may operate the driver in a forward direction to automatically open the door. The controller may stop the driver when an opening of door is completed. The controller may operate the driver in a reverse direction to automatically close the door when it is detected that the driver is being operated in the reverse direction by an external force in a state in which the driver is stopped.

The controller may operate the driver in the reverse direction when a number of pulses per unit time output from the driver is greater than a reference number while the driver is operated in the reverse direction by an external force.

The controller may operate the driver in the reverse direction when a number of pulses per unit time output from the driver is greater than a reference number before a set time is elapsed after the driver is stopped.

The controller may operate the driver in the reverse direction to automatically close the door when a set time is elapsed after the driver is stopped.

According to another aspect, a refrigerator may include a cabinet having a storage space; a door that opens and closes the storage space; a hinge device to allow the door to rotate relative to the cabinet; a door opening and closing device to open and close the door and including a driver; and a controller to control the door opening and closing device. The controller may operate the driver in a forward direction to automatically open the door, and may stop the driver when a rotation speed of the driver becomes less than a limited speed while the driver is operating in the forward direction.

The controller may operate the driver in a reverse direction to automatically close the door immediately after the driver is stopped or after the driver is stopped and a predetermined time is elapsed.

The controller may operate the driver in the forward direction to automatically open the door when a door opening signal is detected within a predetermined time after the driver is stopped.

The controller may operate the driver in a reverse direction to automatically close the door when a door closing signal is detected within a predetermined time after the driver is stopped.

After the predetermined time is elapsed after the driver is stopped, the controller may operate the driver in the reverse direction to automatically close the door.

A case in which the door opening signal is detected is a case in which a number of pulses per unit time generated by a forward operation of the driver is greater than a first reference number.

A case in which the door closing signal is detected is a case in which a number of pulses per unit time generated by a reverse operation of the driver is greater than a second reference number.

After the driver is stopped and a reference time is elapsed, it may be determined whether a door opening signal or a door closing signal is detected. The reference time may be less than the predetermined time.

According to further another aspect, a refrigerator may include a cabinet having a storage space; a door that opens and closes the storage space; a hinge device to allow the door to rotate relative to the cabinet; a door opening and closing device to open and close the door and including a driver; and a controller to control the door opening and closing device. The controller may operate the driver in a forward direction to automatically open the door. The controller may operate the driver in a reverse direction to automatically close the door after an automatic opening of the door is completed. The controller may stop the driver when a rotation speed of the driver becomes less than a limit speed while the driver is operating in the reverse direction.

The controller may operate the driver in the forward direction to automatically open the door when a door opening signal is detected within a predetermined time after the driver is stopped. The controller may operate the driver in the reverse direction to automatically close the door when a door closing signal is detected within a predetermined time after the driver is stopped.

When a predetermined time is elapsed after the driver is stopped, the controller may operate the driver in the reverse direction to automatically close the door.

A case in which the door opening signal is detected is a case in which a number of pulses per unit time generated by a forward operation of the driver is greater than a reference number.

A case in which the door closing signal is detected is a case in which a number of pulses per unit time generated by a reverse operation of the driver is greater than a reference number.

After the driver is stopped and the reference time is elapsed, it may be determined whether the door opening signal or the door closing signal is detected. The reference time may be less than the predetermined time.

The description of the refrigerator described above can be applied to a home appliance as well.

According to one embodiment, there is an advantage in that a door opening angle increases when the door is automatically opened.

According to one embodiment, there is an advantage in that a door can not only open automatically, but also close automatically.

According to one embodiment, there is an advantage of reducing excessive load on a driver at an initial stage of automatic door opening.

According to one embodiment, the door not only opens automatically, but can also be opened manually by the user.

According to one embodiment, there is an advantage in that damage to the driver for automatic opening is prevented and operating noise is reduced when the door is manually opened.

According to one embodiment, the driver is stopped when an obstacle is detected during an automatic opening or automatic closing process of the door, thereby preventing damage to the driver.

According to one embodiment, in a state in which the driver is stopped by detecting an obstacle, if a door closing command or a door opening command is recognized, the driver is operated again to enable automatic opening or automatic closing of the door.

According to one embodiment, when the door is automatically opened and the driver is stopped, if the driver is rotated in a reverse direction by a force in a door closing direction, the door can be automatically closed, so that the door can be automatically closed without a separate sensor.

### BRIEF DESCRIPTION OF THE DRAWINGS

FIG. 1A is a plan view of a refrigerator according to the present embodiment, and

FIG. 1B is a drawing showing a state in which a cover member in FIG. 1A is removed.

FIG. 2A is a drawing showing a state in which a door opening and closing device and a cover member are separated from a refrigerator according to the present embodiment.

FIG. 2B is a drawing showing a state in which a door opening and closing device and a cover member are installed at a refrigerator according to the present embodiment.

FIG. 3 is a perspective view showing a state in which a second frame is removed from a door opening and closing device installed at the refrigerator according to the present embodiment.

FIG. 4 is a plan view showing a state in which a second frame is removed from a door opening and closing device according to the present embodiment.

FIG. 5 is a drawing showing an internal configuration of a door opening and closing device according to the present embodiment.

FIG. 6 is a drawing showing a door opening and closing device in a state in which a door is closed according to the present embodiment.

FIG. 7 is a control block diagram of a refrigerator according to the present embodiment.

FIGS. 8 to 13 are drawings showing a process of automatic door opening.

FIGS. 14 to 16 are drawings showing a process of automatic door closing.

FIG. 17 is a flowchart illustrating a method for controlling a refrigerator according to the present embodiment.

FIGS. 18 and 19 are drawings showing a process of manual door opening.

FIG. 20 is a flowchart illustrating a method of controlling a refrigerator when an obstacle is detected in an automatic opening process of a door.

FIG. 21 is a flowchart illustrating a modified example of a method of controlling a refrigerator when an obstacle is detected in an automatic opening process of a door.

FIG. 22 is a flowchart illustrating a method of controlling a refrigerator when an obstacle is detected in an automatic closing process of the door.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a) and (b) may be used. Each of the terms is merely used to distinguish the corresponding component from other components, and does not delimit an essence, an order or a sequence of the corresponding component. It should be understood that when one component is “connected”, “coupled”, or “joined” to another component, the former may be directly connected, coupled, or jointed to the latter or may be “connected”, coupled”, or “joined” to the latter with a third component interposed therebetween.

In this specification, at least one of component A and component B may be interpreted as including component A, component B, or components A+B.

Furthermore, at least one of component A or component B may be interpreted as including component A, component B, or components A+B.

In this specification, a front surface of the door is a surface forming a front appearance of the door, and a rear surface of the door is a surface facing a cabinet or storage space.

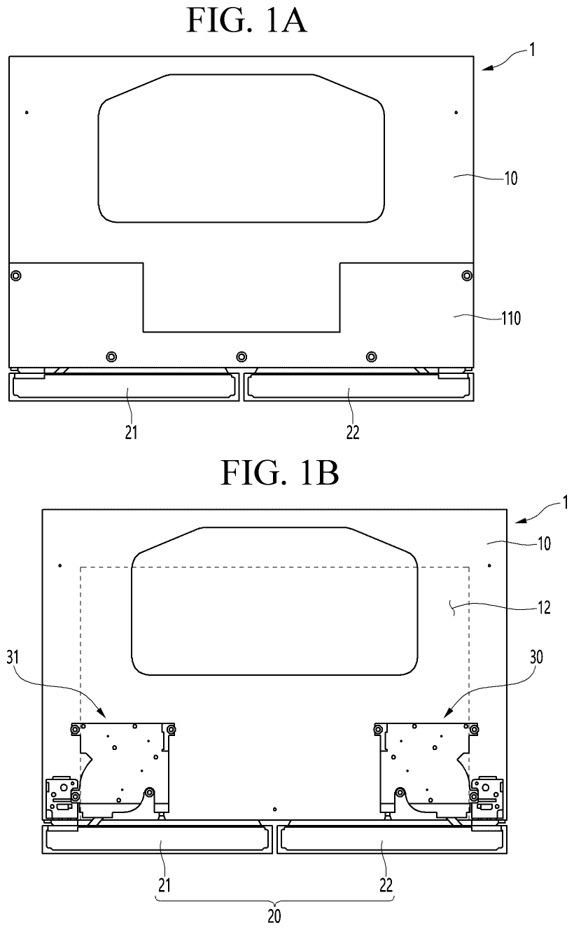

FIG. 1A is a plan view of a refrigerator according to the present embodiment, and FIG. 1B is a drawing showing a state in which a cover member in FIG. 1A is removed.

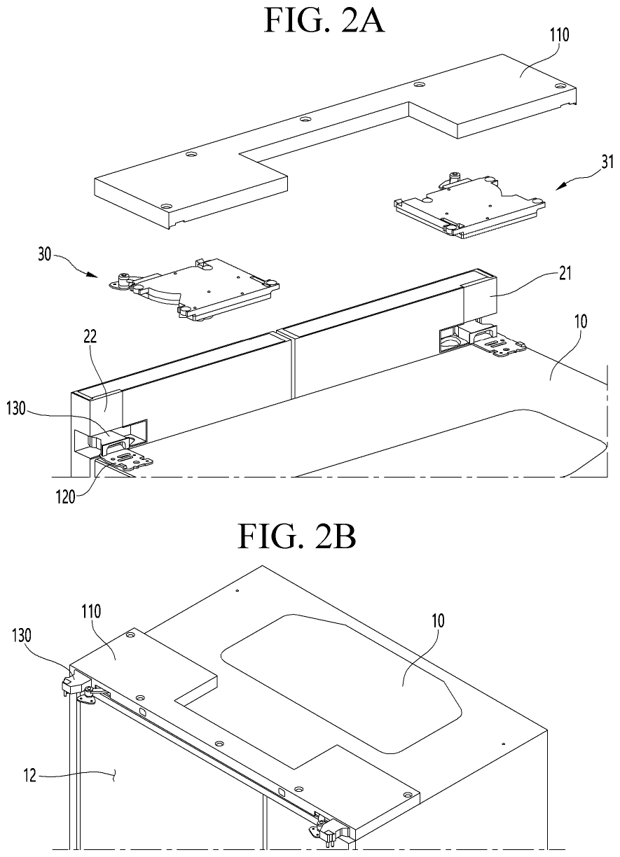

FIG. 2A is a drawing showing a state in which a door opening and closing device and a cover member are separated from a refrigerator according to the present embodiment. FIG. 2B is a drawing showing a state in which a door opening and closing device and a cover member are installed at a refrigerator according to the present embodiment.

Referring to FIGS. 1 and 2, a refrigerator 1 according to the present embodiment may include a cabinet 10 to form a storage space 12 and a door 20 that opens and closes the storage space 12.

The storage space 12 may include, for example, a refrigerating chamber. Alternatively, the storage space 12 may include, for example, a freezing chamber. Alternatively, although not shown, the storage space 12 may further include an additional storage space.

The door 20 may be a refrigerating chamber door or a freezing chamber door. The door 20 may include a first door 21 that opens and closes a portion of the storage space 12. The door 20 may further include a second door 22 that opens and closes another portion of the storage space 12. Alternatively, a single door 20 may open and close a single storage space 12, or may open and close multiple storage spaces 12 simultaneously.

Each of the first door 21 and the second door 22 may be configured as a single door. Alternatively, at least one of the first door 21 or the second door 22 may include a main door and a sub-door.

A refrigerator of the present embodiment may further include a door opening and closing device 30, 31 to open the door 20. When the door 20 includes a plurality of doors 21, 22, the door opening and closing device 30, 31 may open some or all of the plurality of doors 21, 22. When the refrigerator 1 includes a single door 20, the refrigerator 1 may include a single door opening and closing device.

As an example, FIG. 1 illustrates that the first door 21 and the second door 22 are automatically opened and closed by door opening and closing devices 30 and 31, respectively. That is, the refrigerator 1 may include a first door opening and closing device 30 and a second door opening and closing device 31.

Each of the door opening and closing devices 30 and 31 may be arranged symmetrically and have the same structure.

Each of the first door 21 and the second door 22 may be rotatably connected to the cabinet 10 by a hinge device 120. The hinge device 120 may be covered by a hinge cover 130.

The hinge device 120 may be installed, for example, on an upper surface of the cabinet 10. Accordingly, a pair of hinge devices 120 may be spaced apart from each other on the upper surface of the cabinet 10.

The hinge device 120 may include a pin unit. The pin unit may include a plurality of pins that are spaced apart from each other. When the pin unit includes a plurality of pins, a rotation center of the door 20 may move during an opening and closing process of the door 20.

As another example, the pin unit may include a single pin. When the pin unit includes a single pin, a rotation center of the door 20 may be fixed in position during an opening and closing process of the door 20.

As another example, a multi-joint hinge unit including a plurality of bodies may be used as the hinge device 120.

Each of the door opening and closing devices 30, 31 may be positioned at an upper side of the cabinet 10. Each of the door opening and closing devices 30, 31 may be positioned adjacent to each hinge device 120 between the pair of hinge devices 120.

As another example, it is also possible for the door opening and closing device 30, 31 to be positioned at a bottom or side of the cabinet 10. Alternatively, it is also possible for the door opening and closing device 30, 31 to be received within the cabinet 10, and for a structure for opening the door to be protruded outside the cabinet 10.

The refrigerator 1 may further include a cover member 110. The cover member 110 may be installed on an upper surface of the cabinet 10.

The cover member 110 may cover at least a portion of each of the door opening and closing devices 30 and 31. The cover member 110 may cover at least a portion of the hinge device 120. The cover member 110 may cover at least a portion of the hinge cover 130.

Each of the door opening and closing devices 30 and 31 may be installed on the upper surface of the cabinet 10 or may be installed at the cover member 110. When each of the door opening and closing devices 30 and 31 is installed at the cover member 110, the cover member 110 may be installed on the upper surface of the cabinet 10 after each of the door opening and closing devices 30 and 31 is installed at the cover member 110.

In the present embodiment, a single cover member 110 may cover a pair of door opening and closing devices 30, 31 and a pair of hinge covers 130 simultaneously, but is not limited thereto. For example, a plurality of cover members 110 may individually cover each of a pair of door opening and closing devices 30, 31 and a pair of hinge covers 130. Alternatively, the cover member 110 may not cover the pair of door opening and closing devices 30, 31.

Hereinafter, the door opening and closing devices 30 and 31 will be described in detail. At this time, the door opening and closing devices 30 and 31 will be collectively referred to as “door opening and closing device 30.”

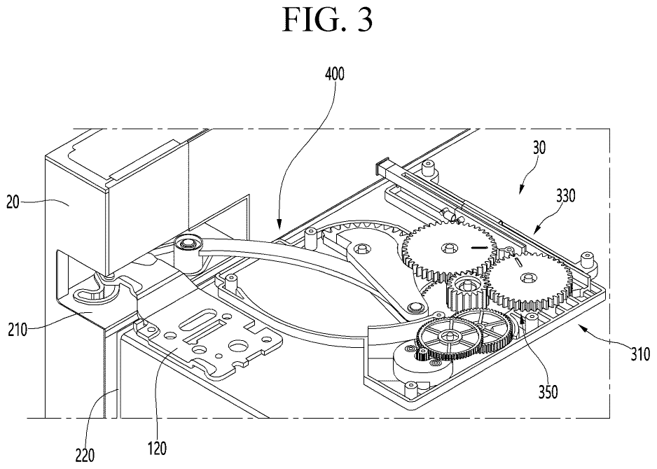

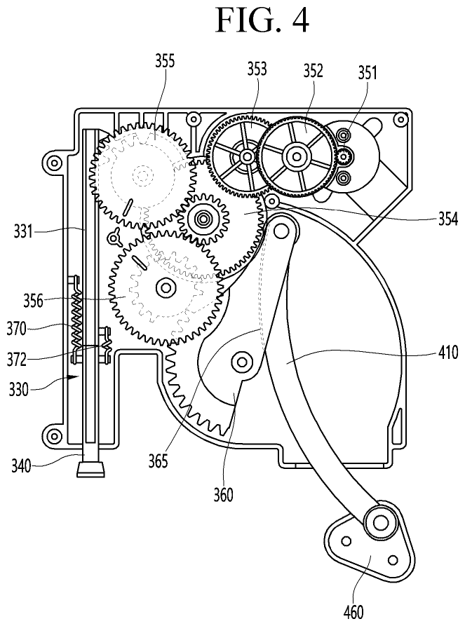

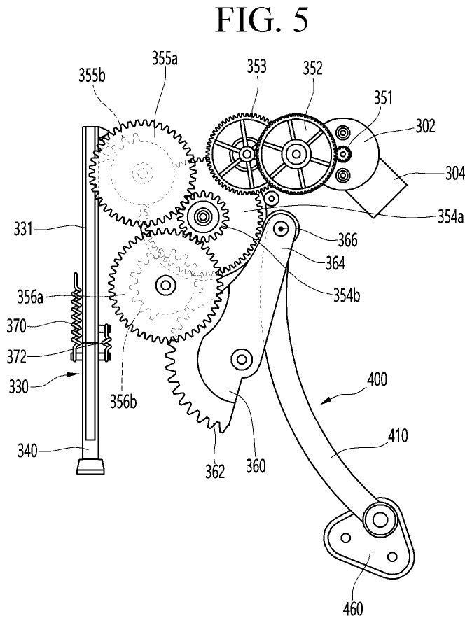

FIG. 3 is a perspective view showing a state in which a second frame is removed from a door opening and closing device installed at the refrigerator according to the present embodiment. FIG. 4 is a plan view showing a state in which a second frame is removed from a door opening and closing device according to the present embodiment. FIG. 5 is a drawing showing an internal configuration of a door opening and closing device according to the present embodiment.

In FIG. 3, the cover member is removed.

Referring to FIGS. 3 to 5, in the present embodiment, the door 20 can be automatically opened by the door opening and closing device 30. Alternatively, the door 20 can be manually opened by a user.

A portion of the door opening and closing device 30 may be connected to an upper side (or lower side) of the door 20.

A gasket 220 may be provided between the door 20 and the cabinet 10 to limit leakage of cold air from the storage space 12. For example, the gasket 220 may be coupled to the door 20. A magnet may be provided inside the gasket 220. The gasket 220 may be maintained in contact with the cabinet 10 by the magnet.

The door 20 may be rotatably connected to the cabinet 10 by the hinge device 120. The door 20 may include a hinge mounting portion 210. The hinge mounting portion 210 may be formed by a rear surface of the door 20 being recessed toward the front. Alternatively, the hinge mounting portion 210 may be formed by one surface of both side surfaces of the door 20 being recessed toward another surface.

The hinge device 120 may be installed at a bottom of the hinge mounting portion 210. The hinge mounting portion 210 may be provided with a pin slot to receive the pin unit, or a guide member to form the pin slot. When the pin unit includes a plurality of pins, the guide member may include a plurality of pin slots or a single pin slot.

The door opening and closing device 30 of the present embodiment may include a driver 302. The driver 302 may include a motor. The motor may, for example, rotate in both directions. The driver 302 may be controlled by a driver printed circuit board (PCB) 304.

The door opening and closing device 30 may further include a power transfer portion 350 to transfer power from the driver 302.

The door opening and closing device 30 may further include a first operating portion 330 (or first door opening portion) that operates by receiving power from the power transfer portion 350.

The door opening and closing device 30 may further include a second operating portion 400 (or second door opening portion) that operates by receiving power from the power transfer portion 350.

In an automatic opening process of the door 20, the first operating portion 330 and the second operating portion 400 may operate sequentially. The second operating portion 400 functions as a door closing portion to close the door during an automatic closing process.

The power transfer portion 350 may include a plurality of gears.

The door opening and closing device 30 may further include a frame 310. A plurality of gears may be rotatably supported on the frame 310. The frame 310 may cover or support at least a portion of a component constituting the door opening and closing device 30.

For example, the plurality of gears may include first to sixth gears 351, 352, 353, 354, 355, and 356.

However, it should be noted that there is no limitation on a number of multiple gears in this embodiment. Furthermore, it should be noted that there is no limitation on shape of the multiple gears.

A first gear 351 may be connected to a shaft of the driver 302. The second to sixth gears 352 to 356 may be reduction gears. A second gear 352 may be connected to the first gear 351. A third gear 353 may be connected to the second gear 352. A fourth gear 354 may be connected to the third gear 353.

A fifth gear 355 may be connected to the fourth gear 354. A sixth gear 356 may be connected to the fourth gear 354 at a position spaced apart from the fifth gear 355.

In this embodiment, the fourth gear 354 may be referred to as a distribution gear or a common gear. That is, when the fourth gear 354 rotates, the fifth gear 355 and the sixth gear 356 may rotate simultaneously.

As another example, the fifth gear 355 may be connected to the fourth gear 354, and the sixth gear 356 may be connected to the fifth gear 355. Alternatively, the sixth gear 356 may be connected to a gear connected to the fourth gear 354 or the fifth gear 355.

The fifth gear 355 may transfer power to the first operating portion 330. Therefore, the fifth gear 355 may be referred to as a first transfer gear or a first transfer portion.

The sixth gear 356 may transfer power to the second operating portion 400. Therefore, the sixth gear 356 may be referred to as a second transfer gear or a second transfer portion.

At least one of the second to sixth gears 352 to 356 may be a two-stage gear having portions with different diameters.

The fifth gear 355 may transfer power to the first operating portion 330 during a portion of an automatic opening process of the door 20. For example, the fifth gear 355 may transfer power to the first operating portion 330 during an initial process of the automatic opening process. The fifth gear 355 may block power transmission to the first operating portion 330 during another process of the automatic opening process. That is, the fifth gear 355 may block power transferred to the first operating portion 330 during a rotation process. Therefore, the fifth gear 355 may be referred to as a first clutch gear.

The fourth gear 354 may include a first portion 354a and a second portion 354b. A diameter of the first portion 354a may be greater than a diameter of the second portion 354b. Each of the first portion 354a and the second portion 354b may have gear teeth formed entirely around a periphery thereof.

The first portion 354a may be connected to the third gear 353.

The fifth gear 355 may include a first portion 355a and a second portion 355b. A diameter of the first portion 355a may be greater than a diameter of the second portion 355b. Gear teeth may be formed entirely around a periphery of the first portion 355a. The first portion 355a may be engaged with the second portion 354b of the fourth gear 354. The second portion 355b may have gear teeth formed only on a portion of a circumference thereof. That is, the fifth gear 355 may include a partial gear.

The second portion 355b may be selectively connected to the first operating portion 330. In a state in which the second portion 355b connected to the first operating portion 330, a rotational force of the fifth gear 355 may be transferred to the first operating portion 330.

The sixth gear 356 may include a first portion 356a and a second portion 356b. A diameter of the first portion 356a may be greater than a diameter of the second portion 356b. Gear teeth may be formed entirely around a periphery of the first portion 356a. The first portion 356a may be engaged with the second portion 354b of the fourth gear 354. The second portion 356b may have gear teeth formed only on a portion of a circumference thereof. That is, the sixth gear 356 may include a partial gear.

In this embodiment, a partial gear may be applied to a gear that rotates less than 360 degrees throughout the automatic opening process of the door 20.

The second portion 356b may be connected to a connection gear 360 described later. In a state in which the second portion 356b is connected to the connection gear 360, a rotational force of the sixth gear 356 may be transferred to the connection gear 360.

The first operating portion 330 may receive power from the driver 302 while connected to the fifth gear 355.

The first operating portion 330 may be movably installed at the frame 310 in a first axial direction. The first axial direction may be, for example, an arrangement direction of the door 20 and the cabinet 10 or a front-back direction of the refrigerator 1.

The first operating portion 330 may receive power from the driver 302 during an initial process of the automatic opening process to separate the gasket 220 from the cabinet 10. Therefore, the first operating portion 330 may also be referred to as a gasket separation portion.

The first operating portion 330 may include a first member 331. The first member 331 may be selectively connected to the fifth gear 355. The first member 331 may be referred to as a rack.

The first operating portion 330 may further include a second member 340. The second member 340 may push the door 20 in an automatic opening process of the door 20. The second member 340 may be referred to as a pusher.

The first member 331 and the second member 340 may be arranged in the first axial direction. The first member 331 and the second member 340 may be arranged in a straight line, for example. Alternatively, a portion of the first member 331 may be arranged in a second axial direction crossing the first axial direction with the second member 340.

The door opening and closing device 30 may further include a first elastic member 370. The first elastic member 370 may connect the second member 340 and the frame 310.

The door opening and closing device 30 may further include a second elastic member 372. The second elastic member 372 may connect the first member 331 and the second member 340. The second elastic member 372 may act to move the first member 331 and the second member 340 together in an automatic opening process of the door 20.

As long as no external force is applied, the first member 331 and the second member 340 may be in contact with the second elastic member 372. In the automatic opening process of the door 20, the first member 331 and the second member 340 may move in a contacted state.

The first elastic member 370 may be a coil spring. The second elastic member 372 may be a coil spring. A length of the first elastic member 370 may be the same as or different from a length of the second elastic member 372. Since a movement distance of the first operating portion 330 in the automatic opening process is greater than a movement distance of the first member 331 in the automatic closing process, a length of the first elastic member 370 may be greater than a length of the second elastic member 372.

As another example, at least one of the first elastic member 370 or the second elastic member 372 may be a torsion spring or a plate spring.

The second operating portion 400 may further include a connection gear 360. The connection gear 360 may be selectively connected to the sixth gear 356. The sixth gear 356 may block power transferred to the second operating portion 400 during rotation. Therefore, the sixth gear 356 may be referred to as a second clutch gear.

The second operating portion 400 may include a link 410. The link 410 may be connected to the connection gear 360. For example, the link 410 may be rotatably connected to the connection gear 360. At least a portion of the link 410 may be rounded. That is, the link 420 may include a curved portion. Alternatively, the link 420 may also include a straight portion.

The connection gear 360 may include a gear portion 362 including a plurality of gear teeth and an arm 364 to which the link 410 is connected. The arm 364 may include a coupling portion 366 to which the link 410 is coupled. The coupling portion 366 may include, for example, a coupling hole, but is not limited thereto.

The arm 364 may include a receiving portion 365 that receives a portion of the link 410 while the link 410 is connected.

The link 410 may be connected to the door 20 by a second connection device 460.

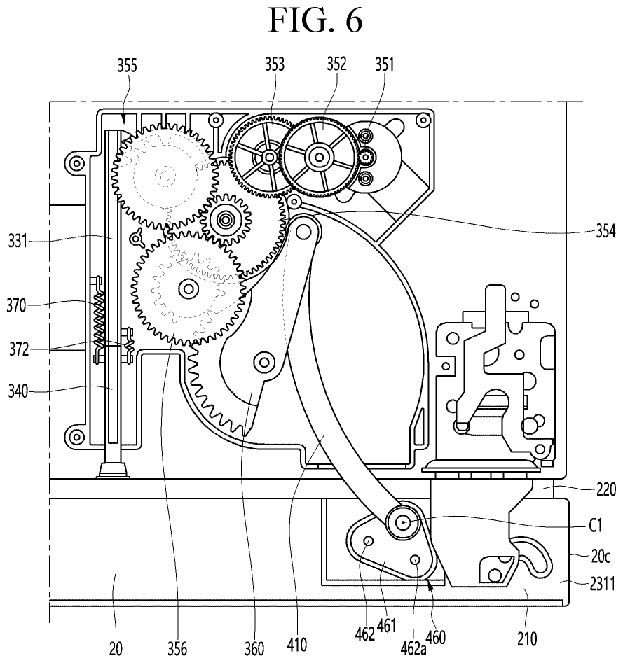

FIG. 6 is a drawing showing a door opening and closing device in a state in which a door is closed according to the present embodiment.

Referring to FIG. 6, the second connection device 460 may be connected to the door 20. For example, the second connection device 460 may be coupled to a bottom surface 211 of the hinge mounting portion 210.

The second connection device 460 may be connected to the door 20 at a position spaced apart from the hinge device 120.

The second connection device 460 may include a coupling body 461 for coupling to the door 20. The coupling body 461 may include a coupling hole 462, 462a through which a coupling member for coupling to the door 20 passes. In order to ensure stable coupling of the coupling body 461, the coupling body 461 may include a plurality of coupling holes 462, 462a.

The second connection device 460 may provide a rotation center C1 of the link 410 for the door 20.

The following describes a process of opening and closing the door.

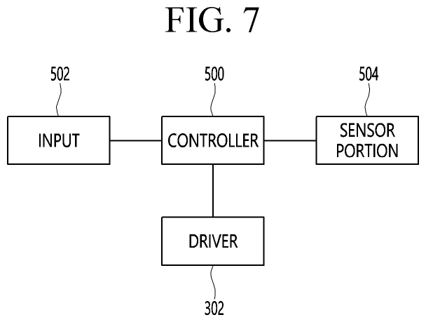

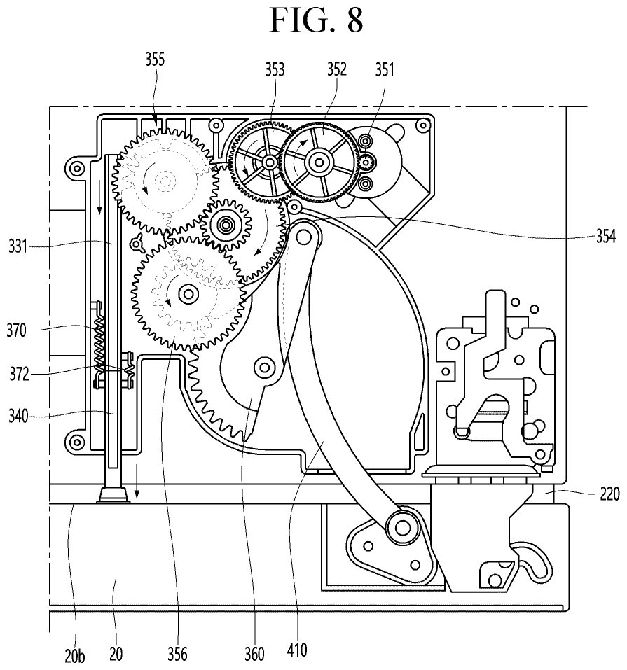

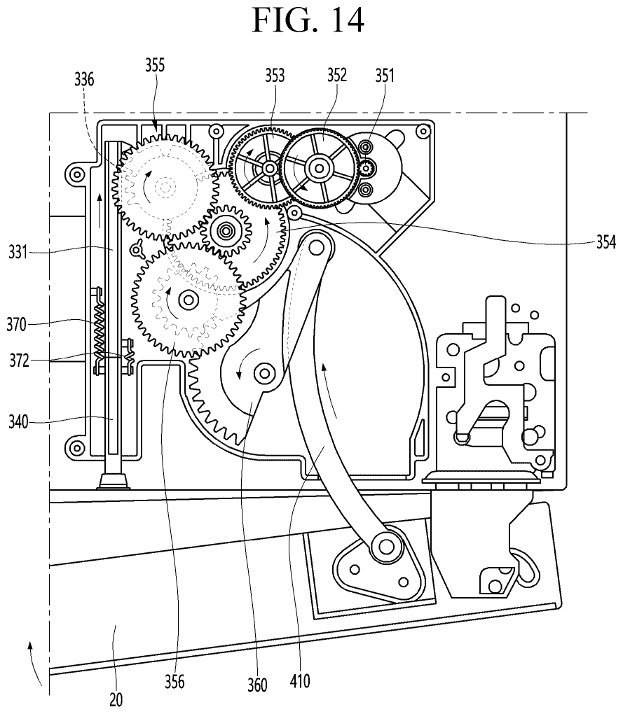

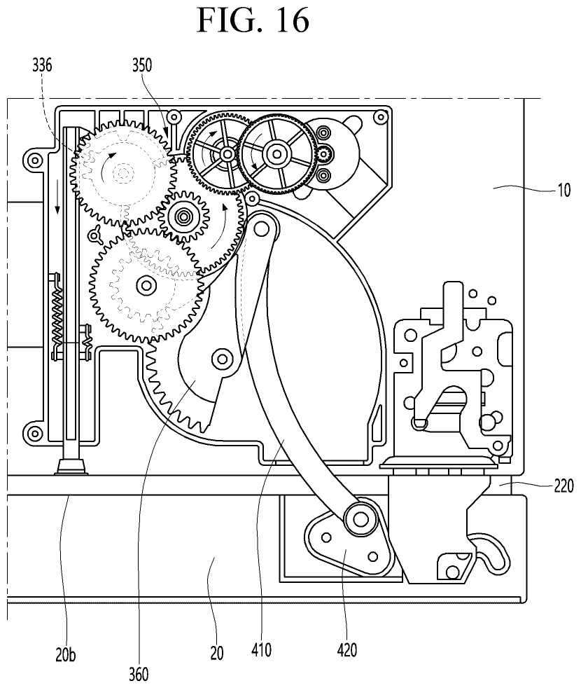

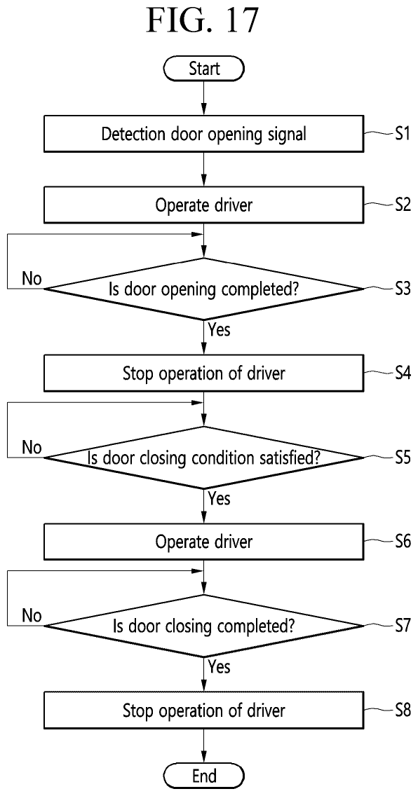

FIG. 7 is a control block diagram of a refrigerator according to the present embodiment. FIGS. 8 to 13 are drawings showing a process of automatic door opening. FIGS. 14 to 16 are drawings showing a process of automatic door closing. FIG. 17 is a flowchart illustrating a method for controlling a refrigerator according to the present embodiment.

Referring to FIGS. 7 to 17, a refrigerator of the present embodiment may further include a controller 500. The controller 500 may be installed at or separated from an object to be controlled. The controller 500 may be positioned inside or outside the object to be controlled.

For example, the controller 500 may be provided at the cabinet 10 or at the door 20. The controller 500 may also receive a control command, a door opening command, or a door closing command from a remote device such as a mobile phone through a communication unit.

The controller 500 may control the driver 302. The controller 500 may be located outside the driver 302. The controller 500 may control the driver 302 alone, and may also control other components in the refrigerator other than the driver 302.

The above refrigerator 1 may further include input 502. The input 502 may input a door opening command for opening the door 20 and/or a door closing command for closing the door 20.

The input 502 may include a touch sensor that detects a user's touch on a front surface of the door 20, or a knock sensor that detects multiple knocks applied to a front surface of the door 20. Alternatively, the input 502 may include a capacitance sensor, a sensor that detects vibration, or a sensor that detects sound waves. Alternatively, the input 502 may include a mechanical button or a touch screen capable of inputting a user's command. Since the input 502 may allow the user to input a command or detect a user's command, the input 502 may also be referred to as an input detector.

The input 502 may be provided at the cabinet 10 or at the door 20.

The refrigerator 1 may further include a sensor portion 504. The sensor portion 504 may detect an opening and closing of the door 20. The sensor portion 504 may be provided at the cabinet 10 or at the door 20.

An operation of the driver 302 for automatic opening of the door 20 may be performed while the door 20 is closed. That is, when an automatic opening command of the door 20 is input while a closing of the door 20 is detected by the sensor portion 504, the driver 302 may be operated.

In a state in which the door 20 is closed, the first operating portion 330 and the second operating portion 400 may be positioned at an initial position as shown in FIG. 6.

At an initial position of the first operating portion 330, the first operating portion 330 may be spaced apart from a rear surface 20b of the door 20.

At least a portion of the connection gear 360 may be positioned between the first operating portion 330 and the second operating portion 400. The second operating portion 400 may be positioned closer to the hinge device 120 of the door 20 than the first operating portion 330.

An automatic opening process of a door will be described below.

In a state in which the door 20 is closed, a door opening command may be input from an input 502. The controller 500 may detect or recognize the door opening signal (S1).

Then, the controller 500 may control the driver 302 to automatically open the door 20 (S2). For example, the driver 302 may be operate in a forward direction.

Referring to FIGS. 6 and 8, the controller 500 may, for example, rotate the motor in a forward direction. When the motor rotates in the forward direction, a power of the motor may be transferred to the first operating portion 330 by the power transfer portion 350.

In this embodiment, the motor, for example, a BLDC motor, may recognize a rotation speed and rotation direction using a number of pulses by a built-in sensor.

A normal operation of the motor may be verified using this motor.

A number of pulses described below may be interchanged with a rotation speed, a reference number can be interchanged with a reference speed, and a limit number can be interchanged with a limit speed.

Referring to FIG. 8, in this embodiment, a forward direction may be, for example, counterclockwise, and a reverse direction may be clockwise.

At an initial position of the first operating portion 330 or an initial position of the fifth gear 355, the fifth gear 355 and the first operating portion 330 are in a disconnected state.

At an initial position of the sixth gear 356 or an initial position of the connection gear 360, the sixth gear 356 and the connection gear 360 are in a disconnected state.

When the motor rotates in the forward direction, a power of the motor is transferred to the fourth gear 354, causing the fourth gear 354 to rotate, and the fifth gear 355 and the sixth gear 356 may rotate simultaneously by a rotation of the fourth gear 354.

When the fifth gear 355 rotates, the fifth gear 355 and the first operating portion 330 are connected. In this state, when the fifth gear 355 rotates, the first operating portion 330 moves in a first direction (or forward direction or opening direction) from an initial position toward a final position.

Since the first member 331 and the second member 340 are connected by the second elastic member 372, when the first member 331 moves in the first direction by a rotation of the fifth gear 355, the second member 340 may also move in the first direction.

As shown in FIG. 8, when the first operating portion 330 moves in the first direction, the first operating portion 330 may be in contact with a rear surface 20b of the door 20. Even when the first operating portion 330 is in contact with the rear surface 20b of the door 20, the second operating portion 400 remains in a stopped state.

As shown in FIG. 8, at a point when the first operating portion 330 is in contact with the rear surface 20b of the door 20, the sixth gear 356 and the connection gear 360 are in a disconnected state.

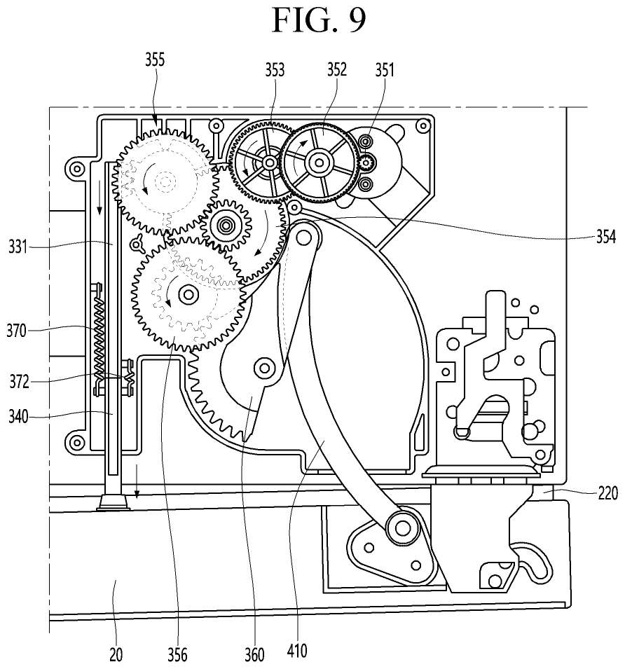

As shown in FIG. 9, when the first operating portion 330 is further moved in the first direction, the first operating portion 330 pushes the door 20, causing the door 20 to be automatically rotated in an opening direction. Accordingly, at least a portion of the gasket 220 begins to separate from the cabinet 10.

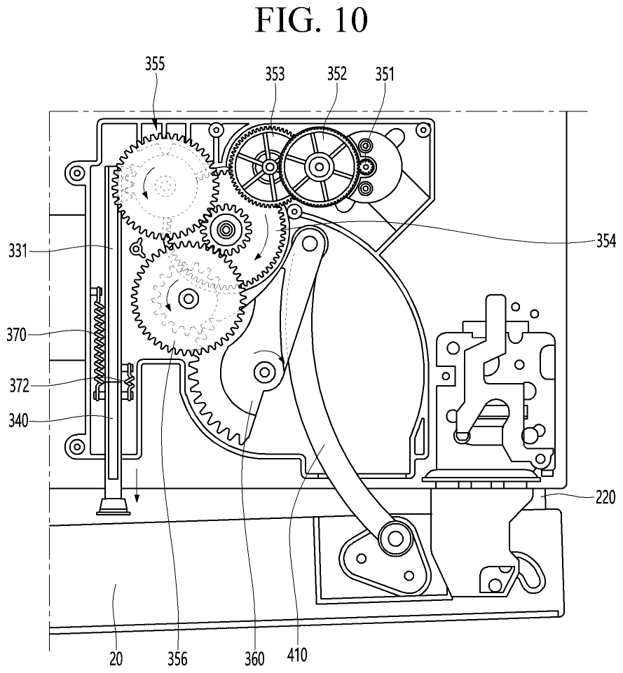

As shown in FIG. 10, the sixth gear 356 and the connection gear 360 are connected by a forward rotation of the sixth gear 356.

After the door 20 starts to be opened from a closed state, and before the sixth gear 356 and the connection gear 360 are connected, the connection gear 360 may be rotated by a rotational force of the door 20 rotated by the first operating portion 330.

In a connection state of the sixth gear 356 and the connection gear 360, the connection gear 360 may rotate when the sixth gear 356 rotates. When the connection gear 360 rotates, the link 410 may move from an initial position toward a door opening position. During a movement of the link 410, the door 20 may be automatically opened by the link 410.

In a process of additionally moving in the first direction in a state in which the first operating portion 330 is in contact with a rear surface 20b of the door 20, the link 410 moves, so that the door 20 may be rotated by the link 410 and the first operating portion 330 may be spaced apart from the rear surface 20b of the door 20, as shown in FIG. 10.

In a state such as FIG. 10, the first operating portion 330 and the second operating portion 400 operate together. For example, the first operating portion 330 may move in the first direction, and the second operating portion 400 may move in an opening direction.

That is, an automatic opening process of the door 20 may include a first opening process in which the first operating portion 330 operates alone, and a second opening process in which the first operating portion 330 and the second operating portion 400 operate together.

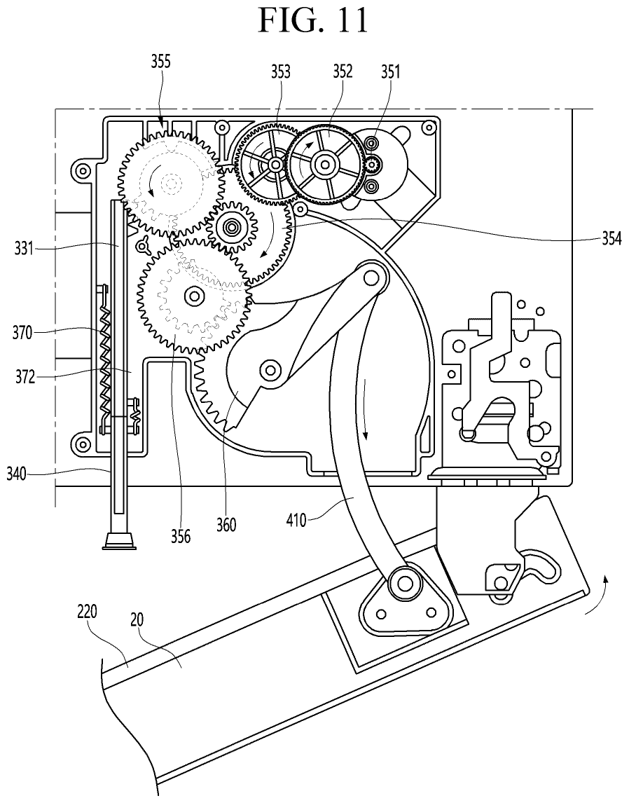

As shown in FIG. 11, by additional movement of the link 410, an opening angle of the door 20 increases, and the gasket 220 may be completely separated from the cabinet 10.

In the present embodiment, the door opening and closing device 30 operates so that the gasket 220 is separated from the cabinet 10 at an initial process of automatic opening of the door 20.

The second operating portion 400 may operate before the gasket 220 is completely separated from the cabinet 10 by operating the first operating portion 330.

Even when the first operating portion 330 is spaced apart from the rear surface 20b of the door 20, the first operating portion 330 may move toward a final position in the first direction.

That is, the first operating portion 330 may move in the first direction from the initial position of FIG. 6 until the first operating portion 330 reaches the final position of FIG. 11.

When the first operating portion 330 reaches the final position, one surface of the first operating portion 330 may be in contact with the frame 310, so that a movement of the first operating portion 330 can be restricted.

The first elastic member 370 may be tensioned until the first operating portion 330 reaches the final position from the initial position.

When an automatic opening of the door 20 begins and the fifth gear 355 is rotated by a predetermined angle or more, the fifth gear 355 and the first operating portion 330 may be disconnected.

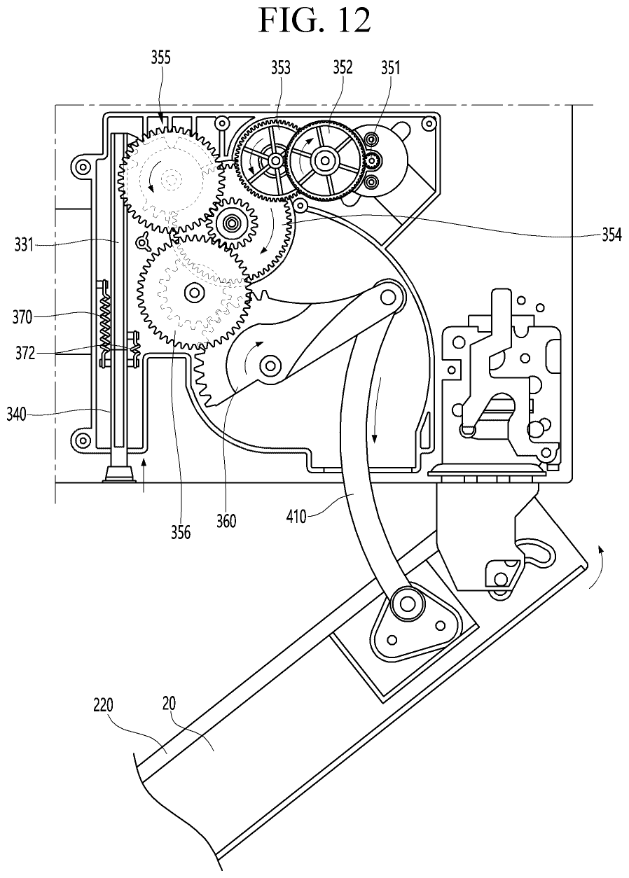

When the fifth gear 355 and the first operating portion 330 are in a disconnected state, an external force acting on the first operating portion 330 is removed, so that the first operating portion 330 may move in a second direction opposite to the first direction by an elastic force of the first elastic member 370, as shown in FIG. 12. That is, the first operating portion 330 may move from the final position to the initial position in the second direction by the elastic force of the first elastic member 370.

When the first operating portion 330 moves to the initial position, another surface of the first operating portion 330 may be in contact with a portion of the frame 310, so that a movement of the first operating portion 330 may be restricted.

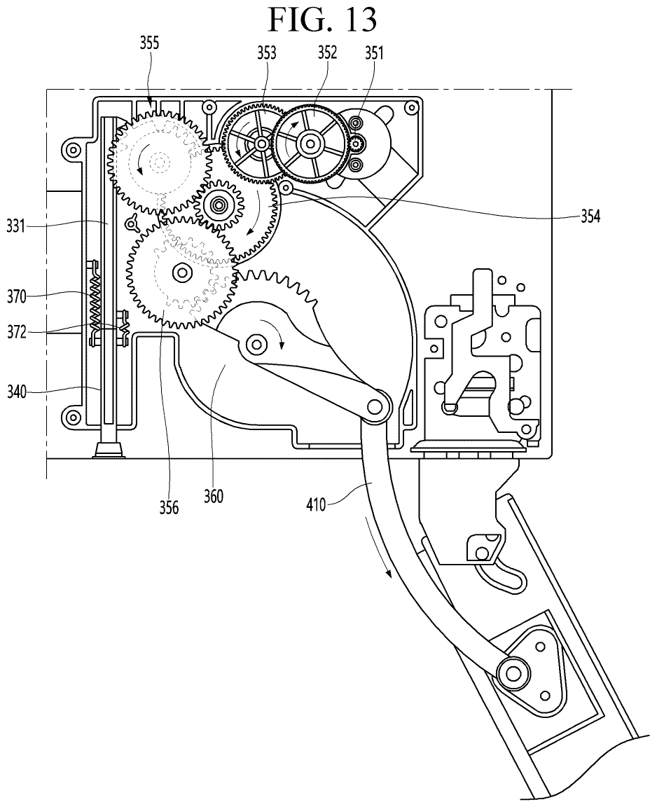

Referring to FIG. 13, the second operating portion 400 may continuously move in the opening direction while the first operating portion 330 is stopped.

Accordingly, an automatic opening process of the door 20 may further include a third opening process in which the second operating portion 400 operates independently.

Referring to FIG. 13, when the second operating portion 400 continuously moves in the opening direction to move to the door opening position, an opening angle of the door 20 becomes maximum. In the present embodiment, a maximum opening angle (or set angle) of the door 20 may be greater than 90 degrees.

When the maximum opening angle of the door 20 is 90 degrees or more, there is an advantage in that the user can easily access the storage space 12 without having to manually open the door 20 additionally.

The controller 500 may determine whether an automatic opening of the door 20 is completed (S3). If it is determined that the automatic opening of the door 20 is completed, the controller 500 may stop the driver 302 (S4).

Meanwhile, after the automatic opening of the door 20 is completed, the controller 500 may determine whether a door closing condition is satisfied (S5).

In a state in which the driver 302 is stopped and the door closing condition is determined to be satisfied, the controller 500 may operate the driver 302 to automatically close the door 20. For example, the motor can be rotated in a reverse direction to automatically close the door 20.

For example, in a case in which the door closing condition is satisfied is a case in which the door 20 may be opened and a set time is elapsed, the door 20 may be opened and a user is not detected, or a door closing command may be input.

Alternatively, if a user is not detected or a door closing command is input before a set time elapses after the motor is stopped, the door closing condition may be determined to be satisfied.

In this case, after the motor is stopped, it can be determined whether the user is detected or a door closing command is input after a reference time less than the set time is elapsed. The reference time may be a time required for stabilization after the motor is stopped.

In a state in which the motor is stopped, a user can push the door 20 in a closing direction. In this case, pulses may be generated as the motor rotates in the reverse direction. If a number of pulses per unit time generated when the motor rotates in the reverse direction is determined to be greater than a reference number, it may be recognized that a door closing command is input. In other words, if a rotation speed of the motor is determined to be greater than a reference speed, it may be recognized that a door closing command is input.

As shown in FIG. 14, when the motor rotates in the reverse direction, the power of the motor is transferred to the second operating portion 400 by the connection gear 360, so that the second operating portion 400 may move in a closing direction from the door opening position to the initial position.

Since the fifth gear 355 and the first operating portion 330 are disconnected during a process of opening the door 20, the first operating portion 330 remains stopped during a portion of a closing process of the door 20.

Accordingly, an automatic closing process of the door 20 may include a first closing process in which only the second operating portion 400 operates.

In a process of the motor rotating in the reverse direction, the fifth gear 355 rotates in the reverse direction. In a process of the fifth gear 355 rotating in the reverse direction, the second portion 355b of the fifth gear 355 may be in contact with the rack gear 336 of the first operating portion 330.

The second portion 355b of the fifth gear 355 may be in contact with the rack gear 336 before the door 20 is completely closed.

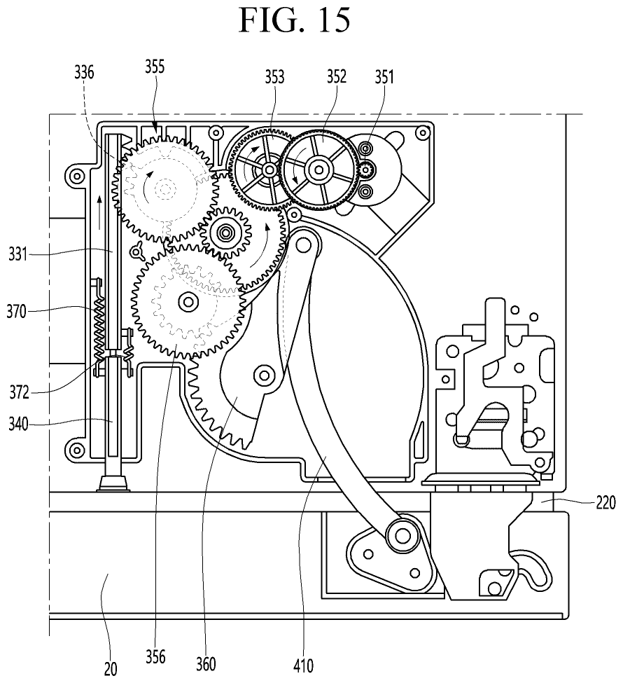

In this state, if the fifth gear 355 is further rotated in the reverse direction as shown in FIG. 15, a rotational force of the fifth gear 355 may be transferred to a rack gear 336 of the first operating portion 330. Then, the first member 331 may move in a second direction in a state in which the second member 340 is stopped.

During a process in which the first member 331 moves in the second direction, the door 20 may be completely closed, and the sixth gear 356 and the connection gear 360 may be disconnected.

Therefore, the automatic closing process of the door 20 may include a second closing process in which the first operating portion 330 and the second operating portion 400 operate together.

As another example, when the door 20 includes an auto-closing device, the sixth gear 356 and the connection gear 360 may be disconnected at a time point when the second portion 355b of the fifth gear 355 is in contact with the rack gear 336 or before the second portion 355b of the fifth gear 355 is in contact with the rack gear 336. That is, the sixth gear 356 and the connection gear 360 may be disconnected before the door 20 is completely closed.

Even when the sixth gear 356 and the connection gear 360 are disconnected, the door 20 may be closed by the auto closing device without a power from the driver 302. In this case, the automatic closing process of the door 20 may include a second closing process in which the second operating portion 400 does not receive a power from the driver 302.

When the first member 331 moves in the second direction, the first member 331 and the second member 340 may be spaced apart by a predetermined distance. The predetermined distance may be a movement distance of the first member 331.

After the first member 331 is separated from the second member 340, if the fifth gear 355 is further rotated in the reverse direction, the first operating portion 330 and the fifth gear 355 may be in a disconnected state. In this case, the first member 331 may return to an original position by an elastic force of the second elastic member 372. That is, the first member 331 may move in the first direction and be in contact with the second member 340.

After the first member 331 is separated, if the fifth gear 355 is further rotated in the reverse direction, the first operating portion 330 and the fifth gear 355 may be reconnected. In this state, when the fifth gear 355 is rotated in the reverse direction, the first member 331 may move in the second direction and be spaced apart from the second member 340.

Since a number of gear teeth formed in the second portion 355b of the fifth gear 355 is plural, a number of times the first member 331 moves in the second direction and then returns to an original position may be equal to a number of gear teeth.

A process of the first member 331 moving in the second direction and then returning to the original position until the fifth gear 355 moves to the initial position may be repeated. When the fifth gear 355 moves to an initial position, the motor may be stopped. In a state in which the fifth gear 355 is moved to the initial position, the fifth gear 355 may be disconnected from the first operating portion 330.

That is, if the controller 500 determines that a closing of the door 20 is completed while the driver 302 is operating (S7), the controller 500 may stop the driver 302 (S8).

Alternatively, if a stop condition of the driver 302 is satisfied while the driver 302 is operating, the controller 500 may stop the driver 302.

According to the present embodiment, at an initial process of an automatic opening process of the door, a power of the driver is transferred to the first operating portion and used for separating the gasket, and during or after a separation of the gasket, the power of the driver is used as an opening force of the door. Therefore, the door gasket may be easily separated during an initial opening process. Furthermore, since a power of the driver is not directly transferred to the link for door opening, an overload on the driver during the initial opening process can be reduced.

In this embodiment, the door not only opens automatically, but also closes automatically, providing enhanced user convenience.

A manual opening process of the door will be described below.

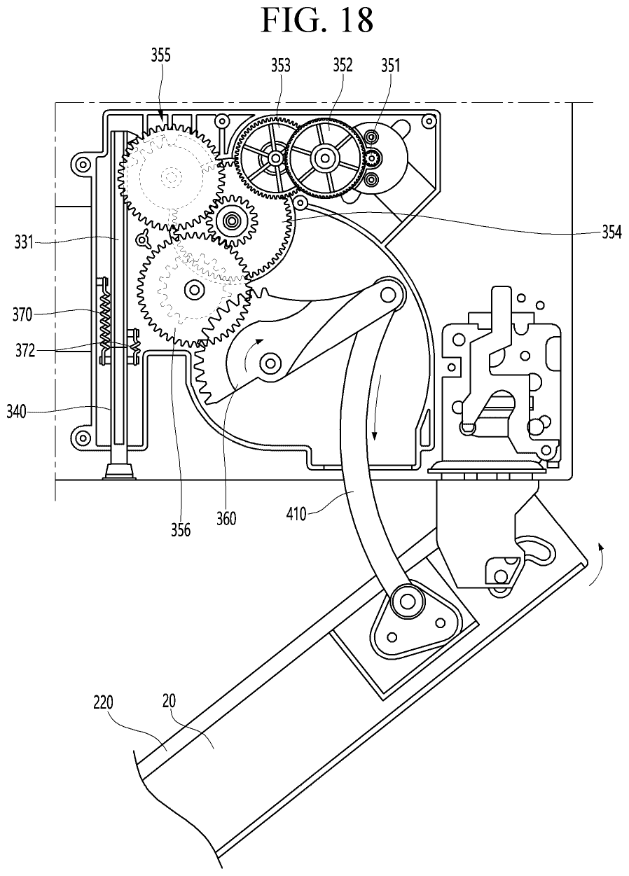

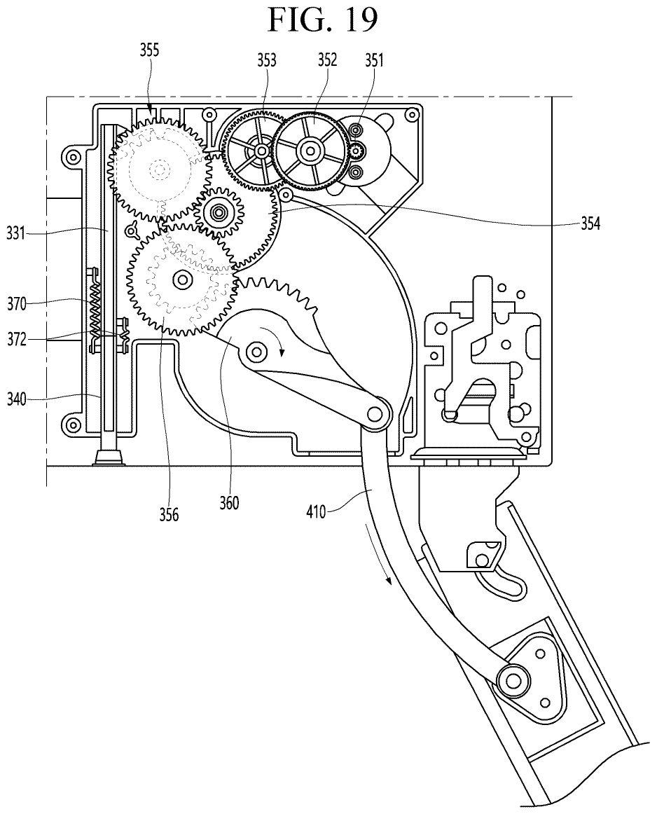

FIGS. 18 and 19 are drawings showing a process of manual door opening.

Referring to FIGS. 18 and 19, a user can manually open the door 20 in a state in which the door 20 is closed.

As described above, in a state in which the door 20 is closed, since the connection gear 360 is in a disconnected state, even if the connection gear 360 rotates, a rotational force of the connection gear 360 is not transferred to the sixth gear 356. That is, an initial position of the sixth gear 356 may be a disconnected position.

When a user holds a handle of the door 20 and pulls the door 20, the door can be rotated. When the door 20 is rotated in an opening direction, the second operating portion 400 connected to the door 20 moves together with the door 20. During a manual opening process of the door 20, the second operating portion 400 may be moved to a door opening position by a rotational force of the door 20.

When the second operating portion 400 moves together with the door 20, the connection gear 360 connected to the second operating portion 400 rotates. However, since the sixth gear 356 is positioned at a disconnected position, the sixth gear 356 does not rotate even if the connection gear 360 rotates.

Therefore, in a manual opening process of the door 20, a manual rotational force of the door 20 is not transferred to the sixth gear 356. The sixth gear 356 is connected to the driver 302 by gears, but the rotational force of the door 20 is not transferred to the driver 302. Accordingly, a load can be prevented from being applied to the driver 302. In addition, since the rotational force of the door 20 is not transferred to the first to sixth gears 351 to 356 during the manual opening process of the door 20, noise generation due to rotation of the gears can be prevented.

Even when the user closes the door 20, the connection gear 360 may rotate, but the sixth gear 356 may remain in a stopped state.

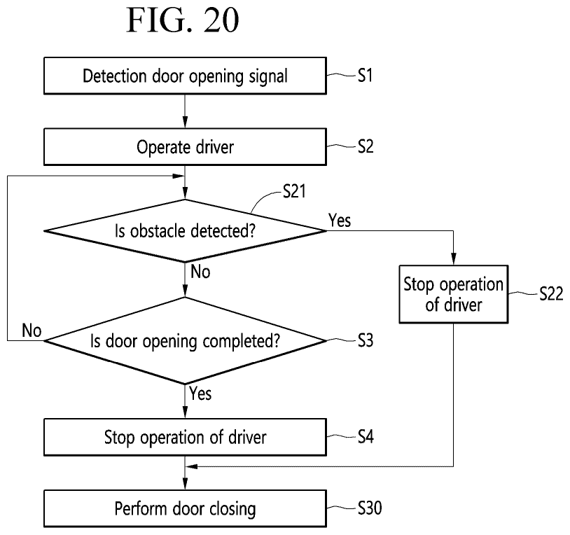

FIG. 20 is a flowchart illustrating a method of controlling a refrigerator when an obstacle is detected in an automatic opening process of a door.

Referring to FIG. 20, when a door opening signal is detected (S1), the controller 500 may operate the driver 302 S2 to automatically open the door 20. For example, the motor can be rotated in the forward direction.

When the motor rotates in the forward direction, an opening angle of the door 20 can be increased. During a process of the motor rotating in the forward direction, the controller 500 may determine whether an obstacle is detected (S21). If the controller 500 determines that an obstacle is detected, the controller 500 may stop the driver 302 (S22).

On the other hand, if the controller 500 determines that no obstacle is detected while the motor is rotating in the forward direction, it is determined whether an automatic opening of the door 20 is completed (S3). If the controller 500 determines that the automatic opening of the door 20 is completed, the controller 500 may stop the driver 302 (S4).

As soon as the driver 302 is stopped or after the driver 302 is stopped and a set time is elapsed, a door closing operation may be performed (S30). The door closing operation may include steps S6 to S8 described in FIG. 17. That is, when an obstacle is detected in an automatic opening process of the door 20, the motor may rotate in the reverse direction so that the door 20 may be automatically closed.

In the present embodiment, in a case in which “an obstacle is detected” during an opening process of the door 20, for example, is a case in which an object around the door 20 may restrict an opening of the door 20, or a user may push the door 20 in a closing direction, restricting the opening of the door 20.

When the motor rotates in the forward direction, a rotation speed (or a number of pulses per unit time) of the motor may be greater than a reference speed (reference number). If the rotation speed of the motor decreases to a speed less than the reference speed and then becomes less than a limit speed (or limit number), it may be determined that an obstacle is detected.

In a case in which there is a difference between the reference speed and the limit speed, if the rotation speed of the motor is less than the reference speed but greater than the limit speed, an automatic opening time of the door 20 increases, but automatic opening of the door 20 is possible.

If the rotation speed of the motor becomes less than the limit speed, there is a risk that the motor may be damaged as the door 20 is not substantially rotated, and thus the motor may be stopped.

In a state in which the motor is stopped, the door closing operation may be performed (S30). The door closing operation may include steps S6 to S8 described in FIG. 17.

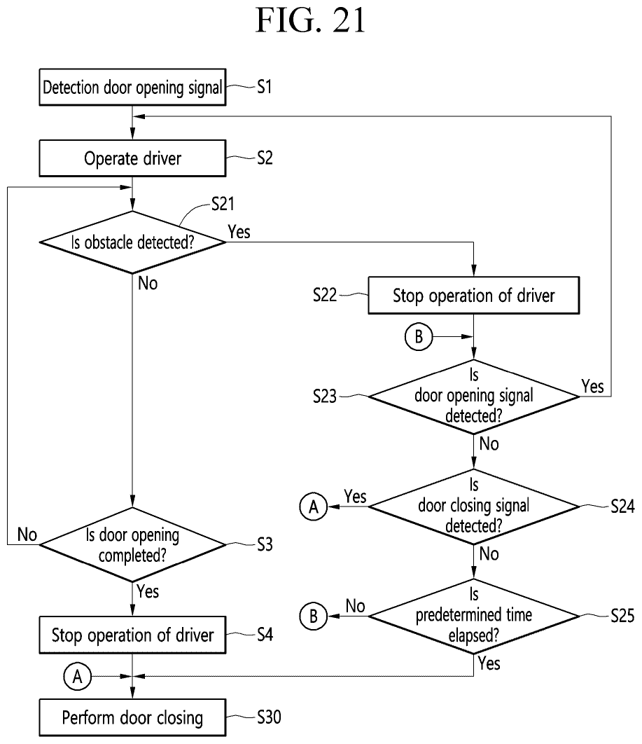

FIG. 21 is a flowchart illustrating a modified example of a method of controlling a refrigerator when an obstacle is detected in an automatic opening process of a door.

Referring to FIG. 21, when a door opening signal is detected (S1), the controller 500 may operate the driver 302 to automatically open the door 20 (S2). For example, the motor may be rotated in the forward direction.

When the motor rotates in the forward direction, an opening angle of the door 20 can be increased. During a process of the motor rotating in the forward direction, the controller 500 may determine whether an obstacle is detected (S21).

If it is determined that no obstacle is detected while the motor is rotating in the forward direction, the controller 500 may determine whether an automatic opening of the door 20 is completed (S3). If it is determined that the automatic opening of the door 20 is completed, the controller 500 may stop the driver 302 (S4).

After the driver 302 is stopped, a door closing operation may be performed (S30). The door closing operation may include steps S6 to S8 described in FIG. 17. That is, if an obstacle is detected in the automatic opening process of the door 20, the door 20 may be automatically closed.

On the other hand, if it is determined that an obstacle is detected in step S21, the controller 500 may stop the driver 302 (S22).

After a reference time is elapsed in a state in which the driver 302 is stopped, the controller 500 may determine whether a door opening signal is detected (S23).

For example, if the user rotates or pulls the door 20 in a direction in which the door 20 opens in a state in which the driver 302 is stopped, the motor may rotate in the forward direction.

When the motor rotates in the forward direction, pulses are counted, and when a number of pulses generated per unit time while the motor rotates in the forward direction is determined to be greater than a first reference number, it can be recognized that a door opening signal is detected or a door opening command is input.

In step S23, if it is determined that a door opening signal is detected, a process can return to step S2. That is, if it is determined that the door opening signal is detected, the controller 500 may operate the driver 302 to automatically open the door 20.

On the other hand, if it is determined in step S23 that the door opening signal is not detected, the controller 500 may determine whether a door closing signal is detected (S24).

For example, in a state in which the driver 302 is stopped and the user rotates or pushes the door 20 in a direction in which the door 20 closes, the motor may rotate in the reverse direction.

When the motor rotates in the reverse direction, pulses are counted, and if it is determined that a number of pulses generated per unit time while the motor rotates in the reverse direction is greater than a second reference number, it can be recognized that a door closing signal is detected or a door closing command is input. At this time, the second reference number may be the same as or different from the first reference number.

In step S24, if it is determined that a door closing signal is detected, the door closing operation may be performed (S30).

On the other hand, in step S24, if it is determined that the door closing signal is not detected, it can be determined whether a predetermined time is elapsed after the driver 302 is stopped (S25). The reference time may be less than the predetermined time.

If it is determined that a predetermined time is elapsed in step S25, the door closing operation may be performed (S30). On the other hand, in step S25, if it is determined that a predetermined time is not elapsed, the process may return to step S23.

To summarize a control method according to this modified example, in a state in which an obstacle is detected during a door opening process and the driver 302 is stopped, when the door closing command is input or a predetermined time is elapsed, the driver 302 may operate to automatically close the door 20.

On the other hand, in a state in which an obstacle is detected during a door opening process and the driver 302 is stopped, when the door opening command is input, the driver 302 may operate to automatically open the door 20.

That is, when an obstacle is detected during the door opening process and the driver 302 is stopped, the door 20 may be automatically opened or closed to reflect a user's intention.

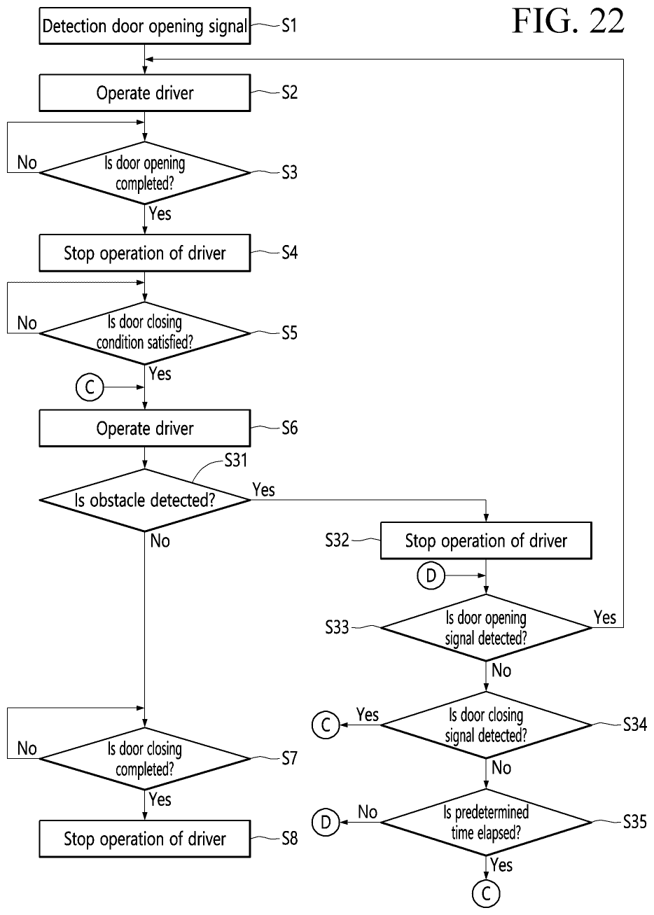

FIG. 22 is a flowchart illustrating a method of controlling a refrigerator when an obstacle is detected in an automatic closing process of the door.

Referring to FIG. 22, when a door opening signal is detected (S1), the controller 500 may operate the driver 302 to automatically open the door 20 (S2). For example, the motor may be rotated in the forward direction.

The controller 500 may determine whether an opening of the door 20 is completed (S3). In step S3, if it is determined that the opening of the door 20 is completed, the controller 500 may stop the driver 302 (S4).

At this time, before step S3 is performed, it is also possible to perform steps S21 to S25 described in FIG. 21.

After the driver 302 is stopped, the controller 500 may determine whether a door closing condition is satisfied (S5).

Since a case where the door closing condition is satisfied is explained above, a detailed explanation will be omitted.

When the door closing condition is satisfied, the controller 500 may operate the driver 302 to automatically close the door 20. That is, the motor may rotate in the reverse direction.

While the motor rotates in the reverse direction, the controller 500 may determine whether an obstacle is detected (S31).

In step S31, if it is determined that no obstacle is detected, the controller 500 may determine whether a closing of the door 20 is completed (S7). If it is determined that the closing of the door 20 is completed, the controller 500 may stop the driver 302 (S8).

Meanwhile, in step S31, if it is determined that an obstacle is detected, the controller 500 may stop the driver 302 (S32).

After the reference time is elapsed in a state in which the driver 302 is stopped, the controller 500 may determine whether a door opening signal is detected (S33).

For example, when the driver 302 is stopped and the user rotates or pulls the door 20 in a direction in which the door 20 opens, the motor may rotate in the forward direction.

When the motor rotates in the forward direction, pulses are counted, and if it is determined that a number of pulses generated per unit time while the motor rotates in the forward direction is greater than a third reference number, it can be recognized that a door opening signal is detected or a door opening command is input. The third reference number may be the same as or different from the first reference number.

In step S33, if it is determined that a door opening signal is input, the process may return to step S2. That is, if it is determined that the door opening signal is input, the controller 500 may operate the driver 302 to automatically open the door 20.

On the other hand, in step S33, if it is determined that a door opening signal is not input, the controller 500 may determine whether a door closing signal is detected (S34).

For example, in a state in which the driver 302 is stopped and the user rotates or pushes the door 20 in a direction in which the door 20 closes, the motor may rotate in the reverse direction.

When the motor rotates in the reverse direction, pulses are counted, and if it is determined that a number of pulses generated per unit time when the motor rotates in the reverse direction is greater than a fourth reference number, it can be recognized that a door closing signal is detected or a door closing command is input. At this time, the fourth reference number may be the same as or different from the third reference number. The fourth reference number may be the same as or different from the second reference number.

In step S34, if it is determined that a door closing signal is input, the process may return to step S6. That is, the driver 302 may operate to automatically close the door 20.

On the other hand, in step S34, if it is determined that the door closing signal is not input, it can be determined whether a predetermined time is elapsed after the driver 302 is stopped (S35). The reference time may be less than the predetermined time.

At this time, the predetermined time in step S35 may be the same as or different from the predetermined time in step S25 of FIG. 21.

In step S35, if it is determined that a predetermined time is elapsed, the process may return to step S6. That is, the driver 302 may operate to automatically close the door 20.

To summarize this control method, in a state in which an obstacle is detected during a door closing process and the driver 302 is stopped, when the door closing command is input or a predetermined time is elapsed, the driver 302 may operate to automatically close the door 20.

On the other hand, in a state in which an obstacle is detected during a door closing process and the driver 302 is stopped, when the door opening command is input, the driver 302 may operate to automatically open the door 20.

That is, in a state in which an obstacle is detected during a door closing process and the driver 302 is stopped, the door 20 maty be automatically opened or closed to reflect the user's intention.

What is claimed is:

1. A refrigerator comprising:
a cabinet having a storage space;
a door that opens and closes the storage space;
a hinge device configured to allow the door to rotate relative to the cabinet;
a door opening and closing device configured to open and close the door and including a driver; and
a controller configured to control the door opening and closing device,
wherein the controller is configured to:
operate the driver in a forward direction to automatically open the door,
stop the driver when an opening of the door is completed, and
operate the driver in a reverse direction to automatically close the door when it is detected that the driver is being operated in the reverse direction by an external force in a state in which the driver is stopped.

2. The refrigerator of claim 1,
wherein the controller is configured to operate the driver in the reverse direction when a number of pulses per unit time output from the driver is greater than a reference number while the driver is operated in the reverse direction by an external force.

3. The refrigerator of claim 2,
wherein the controller is configured to operate the driver in the reverse direction when a number of pulses per unit time output from the driver is greater than a reference number before a set time is elapsed after the driver is stopped.

4. The refrigerator of claim 1,
wherein the controller is configured to operate the driver in the reverse direction to automatically close the door when a set time is elapsed after the driver is stopped.

5. A refrigerator comprising:
a cabinet having a storage space;
a door that opens and closes the storage space;
a hinge device configured to allow the door to rotate relative to the cabinet;
a door opening and closing device configured to open and close the door and including a driver; and
a controller configured to control the door opening and closing device,
wherein the controller is configured to:
operate the driver in a forward direction to automatically open the door, and
stop the driver when a rotation speed of the driver becomes less than a limited speed while the driver is operating in the forward direction.

6. The refrigerator of claim 5,
wherein the controller is configured to operate the driver in a reverse direction to automatically close the door immediately after the driver is stopped or after the driver is stopped and a predetermined time is elapsed.

7. The refrigerator of claim 5,
wherein the controller is configured to operate the driver in the forward direction to automatically open the door when a door opening signal is detected within a predetermined time after the driver is stopped, and
the controller is configured to operate the driver in a reverse direction to automatically close the door when a door closing signal is detected within the predetermined time after the driver is stopped.

8. The refrigerator of claim 7,
wherein after the predetermined time is elapsed after the driver is stopped, the controller is configured to operate the driver in the reverse direction to automatically close the door.

9. The refrigerator of claim 7,
wherein a case in which the door opening signal is detected is a case in which a number of pulses per unit time generated by a forward operation of the driver is greater than a first reference number.

10. The refrigerator of claim 7,
wherein a case in which the door closing signal is detected is a case in which a number of pulses per unit time generated by a reverse operation of the driver is greater than a second reference number.

11. The refrigerator of claim 7,
wherein after the driver is stopped and a reference time is elapsed, it is determined whether the door opening signal or the door closing signal is detected.

12. The refrigerator of claim 11,
wherein the reference time is less than the predetermined time.

13. A refrigerator comprising:
a cabinet having a storage space;
a door that opens and closes the storage space;
a hinge device configured to allow the door to rotate relative to the cabinet;
a door opening and closing device configured to open and close the door and including a driver; and
a controller configured to control the door opening and closing device,
wherein the controller is configured to:
operate the driver in a forward direction to automatically open the door,
operate the driver in a reverse direction to automatically close the door after an automatic opening of the door is completed,
stop the driver when a rotation speed of the driver becomes less than a limit speed while the driver is operating in the reverse direction.

14. The refrigerator of claim 13,
wherein the controller is configured to operate the driver in the forward direction to automatically open the door when a door opening signal is detected within a predetermined time after the driver is stopped.

15. The refrigerator of claim 14,
wherein a case in which the door opening signal is detected is a case in which a number of pulses per unit time generated by a forward operation of the driver is greater than a reference number.

16. The refrigerator of claim 14,
wherein after the driver is stopped and a reference time is elapsed, it is determined whether the door opening signal is detected, and
the reference time is less than the predetermined time.

17. The refrigerator of claim 13,
wherein the controller is configured to operate the driver in the reverse direction to automatically close the door when a door closing signal is detected within a predetermined time after the driver is stopped.

18. The refrigerator of claim 17,
wherein after the driver is stopped and a reference time is elapsed, it is determined whether the door closing signal is detected, and
the reference time is less than the predetermined time.

19. The refrigerator of claim 17,
wherein in a case in which the door closing signal is detected is a case in which a number of pulses per unit time generated by a reverse operation of the driver is greater than a reference number.

20. The refrigerator of claim 13,
wherein when a predetermined time is elapsed after the driver is stopped, the controller is configured to operate the driver in the reverse direction to automatically close the door.
